(19) United States
(12) Patent Application Publication
(10) Pub. No.: US 2015/0213509 A1
(43) Pub. Date: Jul. 30, 2015

(54) REAL TIME PACING OF ONLINE VIDEO ADVERTISEMENTS

(71) Applicant: Yahoo! Inc., Sunnyvale, CA (US)

(72) Inventor: Gian Paolo Musumeci, Berkeley, CA (US)

(73) Assignee: Yahoo! Inc., Sunnyvale, CA (US)

(21) Appl. No.: 14/607,638

(22) Filed: Jan. 28, 2015

Related U.S. Application Data
(60) Provisional application No. 61/932,755, filed on Jan. 28, 2014.

(51) Int. Cl. G06Q 30/02

(52) U.S. Cl. CPC G06Q 30/0272; G06Q 30/0275; G06Q 30/0277

(57) ABSTRACT

Techniques and systems are provided for fulfilling an advertisement campaign where online advertisements are paced by controlling, in real time, how many advertisements are served to users in a given time interval. Audit information gathered from a viewer's device may also be used to provide input to the real time pacing of advertisements.

### CROSS REFERENCE TO RELATED APPLICATIONS

This application claims the benefit of priority of U.S. Provisional Patent Application No. 61/932,755, filed on Jan. 28, 2014, and which is incorporated by reference herein in its entirety.

### TECHNICAL FIELD

The present disclosure generally relates to digital video advertisement insertion.

### BACKGROUND

Online advertisers pay for the opportunity to display their ads to online users. Many online information providers, such as web site operators, generate revenue by placing advertisements on their web pages accessed by online users. Online advertisements can be in various forms, including banners of text or graphics placed within the web page being displayed to a user. In recent years, multimedia ads, including digital video segments, have been gaining popularity in online advertising. Video is often a compelling medium to communicate a commercial message more forcefully. Online video advertising tends to be resource intensive and, as such, advertisers have to pay more money for placing video advertisements.

Advertisers often run their advertisements as “advertisement campaigns” in which certain products or services are advertised over a duration (e.g., a week or a month or until a certain time) and targeted towards certain users.

### SUMMARY

The present document provides techniques for controlling a rate at which advertisements are delivered to users via an online advertisement bidding exchange. The rate of delivery, i.e., the number of advertisements delivered per a unit of time, may be specified by the advertiser and/or decided based on run time statistics gathered from the online advertisement bidding exchange.

In one exemplary aspect a method for controlling online delivery of video advertisements in a network of communication devices or computers includes receiving information about a desired total number of advertisements to be served out for an advertisement campaign in the network over a first time period having a first duration, dividing the first time period into multiple second time periods having a plurality of second durations, for each given second time period, calculating a nominal target number representing advertisements to be served in the given second time period, checking how many previously served advertisements for the advertisement campaign were successfully received at user devices, revising, based on the checking and the nominal target number, the nominal target number to an actual target number, at a given time within the given second time period: determining a number of advertisements already served in the given second time period prior to the given time, comparing the number of advertisements already served in the given second time period with the actual target number, and when the actual target number is greater than the number of advertisements already served in the given second time period, then participating for the advertisement campaign in a next advertisement serving opportunity, and when the actual target number is less than or equal to the number of advertisements already served in the given second time period, then refraining from participating for the advertisement campaign in the next advertisement serving opportunity.

In another aspect, a computer program product comprising a computer-readable medium having code stored thereupon is disclosed. The code, when executed, causes a processor to implement a method of controlling delivery of video advertisements to online users, including calculating, based on an ad campaign, a first quantity indicative of a target number of ads for delivery during a current pacing interval, determining, at a current time, a second quantity indicative of a number of times ads from the ad campaign were served to the online users during the current pacing interval and up to the current time, and deciding, based on the first quantity and the second quantity, whether or not to bid for an ad serving opportunity for the ad campaign at the current time.

In yet another aspect, an online video advertisement delivery system includes a front end server communicatively coupled to a plurality of user devices. The front end server is configured to deliver video advertisements to the plurality of user devices and periodically generate reports of how many video advertisements were delivered in a report period. A billing and reporting mechanism is configured to receive digital video advertisement playback information from the plurality of user devices and remove redundancies and errors from the received digital video advertisement playback information to generate a billable count of advertisements served for a given advertisement campaign. A pacer module is configured to receive the billable count of advertisements and an instantaneous number of video advertisements served in a predefined prior first time window and control, based on the billable count of advertisements and the instantaneous number of video advertisements served in the predefined prior time window, a number of video advertisements to be placed in an upcoming second time window.

These, and other, aspects are disclosed in greater detail in detailed description below, with reference to the drawings.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example of a high level architecture for an online video advertisement system.

FIG. 2 illustrates an example of an online video advertisement system having multiple bidding exchange platforms.

FIG. 3 depicts examples of timelines for advertisement placements in an online video advertisement delivery system.

FIG. 4 is a flowchart representation of an example process of monitoring.

FIG. 5 is a block diagram representation of an example apparatus for debugging a video advertisement system.

### DETAILED DESCRIPTION

In the following detailed description, numerous specific details are set forth to provide an understanding of the features in the present disclosure. The specific examples or embodiments of the present disclosure may be practiced without some of these specific details. In other instances, certain well-known structures and techniques may have not been shown or described in detail and are part of the present disclosure.

Advertisements on websites may be in the form of static banners or animation. With advances in technologies, video advertisements can be played out to the user prior to providing a video or a webpage that the user has requested (often called pre-rolling). Such video ads can be valuable marketing opportunities for various products or services. In various systems that include video advertisements, a number of coordinated message exchanges may happen “behind the scene” between the time a user selects a video content for viewing or clicks on a link (e.g., a user resource locator URL) to the time a video advertisement begins to play out prior to providing the user-requested content. For example, often, the opportunity to display a video advertisement to the user is auctioned to multiple interested parties, or bidders. Responses are received from the multiple bidders and a decision is made based on the received bids and other system operational rules about a winning bid. The winning bidder is then given the opportunity to display the video advertisement to the user.

Advertisers often run advertisement campaign. For example, an advertiser may wish to advertise a new product or a new automobile or a new movie prior to its release. An advertisement campaign is often associated with a time window over which it is active. For example, a new product launch may have a corresponding advertisement campaign that lasts from six months prior to the launch date to two months after the product is launched (a total of eight months active time window). As another example, a movie may be advertised up to the date it is released in theaters. An advertisement campaign may also specify desired number of placements for a type of target audience. For example, one advertisement campaign may specify 100,000 ad placements over a one month period. Another advertisement campaign may specify 200,000 ad placements to men and 100,000 ad placement to women between the ages of 30 to 50, and so on.

For an advertisement campaign that specifies a total number of ad placements over a defined time window (e.g., 100,000 ad placements over a one month period), advertisers may implicitly or explicitly desire to have deliveries spread out relatively evenly over the period. For example, an advertiser may not want all ads to be served out on the first day of a 1-month ad campaign. In some embodiments, the advertiser may provide certain timing requirements—e.g., the advertisements should be uniformly spread over a week, or that more ads should be showed on a weekend that weekdays, and so on.

The above-described scenarios of quickly exhausting the entire ad campaign budget are possible when video advertisements are delivered to online users using the above-described bidding process without controlling the rate of ad placement. In a bidding scenario, an ad campaign that has a relatively high budget may win out every single bid request by outbidding others by paying a slightly higher price such as a single penny, and without further controlling the pace of ad placement, the ad campaign may end up serving out its entire budgeted quota of ads in a short time. Prior art advertisement insertion systems do not provide for such a controlled delivery in which ads are paced out according to an advertisement campaign.

Online placement of advertisements through a bidding process leads to additional complexities in being able to serve out advertisement uniformly over a period of time. While advertisers are typically interested in serving out of ads uniformly over a time period, they are often more interested in a uniform consumption rate—i.e., users actually viewing ads at a uniform rate over a period of time. For static ads, the serve out rate and the consumption rate may be identical, e.g., there is a high likelihood that when a web page is served out by a server, the web page gets displayed to a user. Such a situation may not be the case in delivery of video advertisements to online users. As previously noted, for various reasons such as transmission errors, delays and format incompatibilities, a served-out video advertisement may not actually be displayed to a user or seen by a user.

Another complexity associated with online delivery of video advertisements relates to inaccuracies in the statistics about video deliveries and consumption based on how the statistics is captured. For example, in some other bidding systems, when a particular advertiser wins a bid for an ad placement, this bidding win is counted as one served ad for the ad campaign. However, mere winning the bid for an ad placement need not guarantee that a corresponding ad is in fact shown to the user and thus is a served ad after the showing.

Another complexity associated with online delivery of video advertisements that the time lag between the times at which an ad is served out and the time at which the system receives a feedback about whether that ad was successfully displayed to a user. Depending on operational parameters, this time lag could be up to 2 hours or more. As a result of this time lag, a system that is counting how many ads are being served for an ad campaign may count, e.g., 1,000 ads being served out in a 10 minute span, only to find out 2 hours later that of the 1,000 ads, only 600 ads were actually played back to the users.

The present document provides techniques that can be used in ways that overcome the above-discussed operational limitations, among others, to control a pace of delivery of online video advertisements.

In the specific examples disclosed herein, various terms are used.

As used herein, the term “1×1” means an “Impression Pixel.” The abbreviation ADM refers to an administrator's dashboard. For media's purposes, this tool may be used to see the fill rate of integrated publishers' ad calls on a daily basis to help optimize delivery of campaigns.

As used herein, the term Billable Impressions means impressions that the advertisement exchange platform gets paid for.

As used herein, the term Billable Revenue refers to the revenue generated from the campaigns, as tracked in the 3rd party reports.

As used herein, the term Behavioral Targeting (referred to as “BT”) refers to targeting approach utilizing 3rd party data sets and segmentation to display ads to users who have expressed interest or intent to purchase in certain verticals. Example: in-market for a car, interested in animals/pets, golf enthusiast, etc.

As used herein the term BRX (BrightRoll Ad Exchange) refers to a technology platform, enabling buyers and sellers to access video inventory in a self-service and scalable capacity.

As used herein, the term Buy refers to a user interface for buyers (e.g. advertisers).

As used herein, the term Companion (also called “300×250” or “banner”) refers to a banner running adjacent to preroll and usually remaining persistent and clickable after preroll is completed (size is typically 300×250 pixels).

As used herein, the term Cost refers to publisher costs; tracked by media, paid by finance.

As used herein, the term CPC (cost per click) refers to pricing model in which advertisers pay per click, instead of on a standard CPM model.

As used herein, the term CPE (cost per engagement) refers to cost per video starts.

As used herein, the term CPM (cost per thousand imps) refers to cost per (impressions/1,000). Pricing model for online advertising can be based on impressions or views where the advertiser pays the publisher a predetermined rate for every thousand impressions.

As used herein, the term CPV (cost per view) refers to pricing model based on payment per completed view.

As used herein, the term CTR refers to click through rate, which is a Standard metric used to gauge campaign performance.

As used herein, the term Discrepancy refers to difference between two reporting systems' impression counts.

As used herein, the term Fill rate refers to the percentage of calls an integrated publisher sends that are filled by ads. For example, a publisher could send 500 calls but we may only have 400 ads to send them; therefore, the fill rate would be 80%. If we had 500 ads to send them, the fill rate would be 100%.

As used herein, the term Flight refers to duration of a campaign or line item of an order; broken down by dates.

As used herein, the term Impression pixel refers to a piece of code that tracks impression loads of an ad on a website (also referred to as a 1×1).

As used herein, the term InBanner (shortened to IBV) refers to video running in regular display units (typically 300×250 in sizes).

As used herein, the term Integrated Pub refers to publisher whom we've established both payment terms and completed integration where we can serve videos directly into their player.

As used herein, the term Inventory/Remnant Inventory refers to inventory is the volume of impressions a publisher has available. Remnant inventory is the entire unsold inventory a publisher has not been able to sell to direct buyers, and then offers to networks at a discounted rate.

As used herein, the term Margin refers to profit/revenue (in %).

As used herein, the term Pacing—campaign delivery performance with date of flight taken into account refers to total delivered imps/(current days in flight*(total imps/total days)).

As used herein, the term Performance Metrics—the metrics on which a campaign is judged (i.e.: click through rate, completion rate, acquisitions, etc.).

As used herein, the term Preroll refers to an instream ad unit, running ahead of user initiated video content.

As used herein, the term Search & Keyword retargeting refers to a module that allows advertisers to find relevant users identified in our network through use of third-party vendor data and cookie-ing.

As used herein, the term Signed Pub refers to publisher (e.g., an ad viewer-visited web site) with established fixed payment terms with.

As used herein, the term Survey/Study refers to research collected by a 3rd party vendor to establish campaign branding performance.

As used herein, the term Start, Middle and End Pixels (Quartile Reporting) refers to pieces of code that track the duration of the video view. End pixels track completed views. Duration data cannot be gathered without implementing these pixels.

As used herein, the term Third-Party Reporting refers to external ad-server reporting used by clients to verify proper ad delivery (typically DART or Atlas).

As used herein, the term VAST refers to stands for Video Ad Serving Template.

As used herein, the term Video Block refers to a product offering which allows advertisers to buy out a majority of our network during a 1-3 day period. Typically priced on a CPV basis.

As used herein, the term VPAID refers to stands for Video Player-Ad Interface Definition.

### Examples of System Architecture

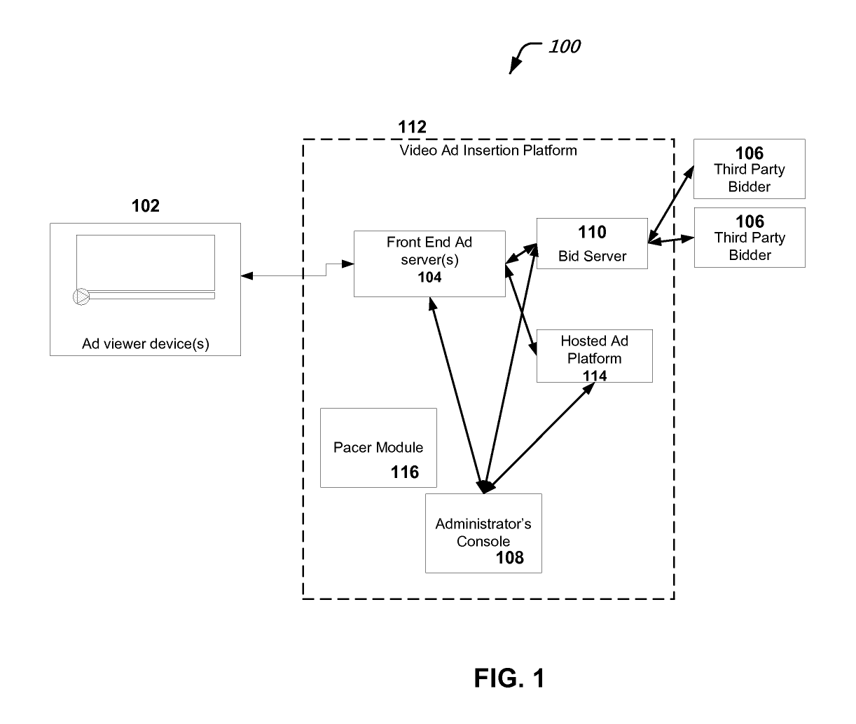

FIG. 1 depicts a simplified view of example online video advertisement insertion architecture 100. An ad viewer's device 102 (e.g., a wireless or a mobile device, as discussed above) may be communicatively coupled (e.g., via the internet and a wired or wireless connection) with a front end ad server 104. In some embodiments, the front end ad server 104 (or, in short, ad server 104) may be the point of entry/exit of communication messages between viewer devices and a video ad insertion platform 112 (hence the name “front end” server). The ad server 104 may communicate bids to show video ads to the device 102 to multiple bidders 106 via a plurality of bid server platforms 110. The ad server 104 may further be in communication with a hosted ad platform 114 and exchange bid request/bid response messages for insertion of advertisements from advertisers hosted by the hosted ad platform 114. An operator console 108 may be provided to control the operation of the ad server 104 and bid servers 110. The bid servers 110 may also be sometimes called the bidding interface because these servers provide an interface between third party bidding servers and the online video advertisement service.

The ad server 104 may perform functions such as handling incoming ad requests from multiple ad viewer devices 102, and respond with an ad or a “no ad” placement. The ad server 104 may operate on a time budget, e.g., 50 to 100 msec. within which it responds to an ad request. The ad server 104 may provide ad data to the viewer device 102 using VAST (video ad serving template) format. The decision about which advertisement to be sent may be based on various factors and real time data such as publisher placement, uniform resource locator (URL), a geographic location of the viewer device, time of day, demographic segment to which the viewer belongs, and so on.

As an example, in Brightroll's system the Ad server 104 can be a Real Time Ad Server (RTAS) and the bid server 110 can be an RTB-D.

When the ad server 104 receives a video placement request from the viewer's device 102, the ad server 104 may pass on the request to multiple bid servers 110. The request may include information about the viewer, the viewer's demographic profile and other rules associated with the ad placement opportunity that may influence the selection of a winning bid.

The bid servers 110 in turn request bids from multiple third party bidders 106. In some embodiments, no explicit bid requests may be generated for the hosted ad platform 114. When bids are received from third party bidders, and/or the hosted ad platform, and/or at the end of a time period (e.g., 90 milliseconds), a decision is made about the winning bid. In some embodiments, the winning bid not only will have the highest dollar value but also should match the demographic profile of the viewer. For example, if the viewer is on the West coast, an advertisement for users on East coast may not be allowed to win bid even when the third party bidder bids the highest dollar value.

Next, the winning bidder is notified of winning the bid. The winning bidder is provided with information to allow the winning bidder to transmit a video advertisement to the viewer.

A pacer module 116 in the video ad insertion platform 112 may be in communication with other servers (e.g., front end server 104, bid server 110, administrator's console 108, hosted ad platform 114, etc.) in the system 100. The pacer module 116 may control the rate at which advertisements are served out on a per period basis. The pacer module may control whether or not to bid for an advertisement request, based on the rate at which ads are being served out for an ad campaign. Additional features of the pacer module 116 are described in this document.

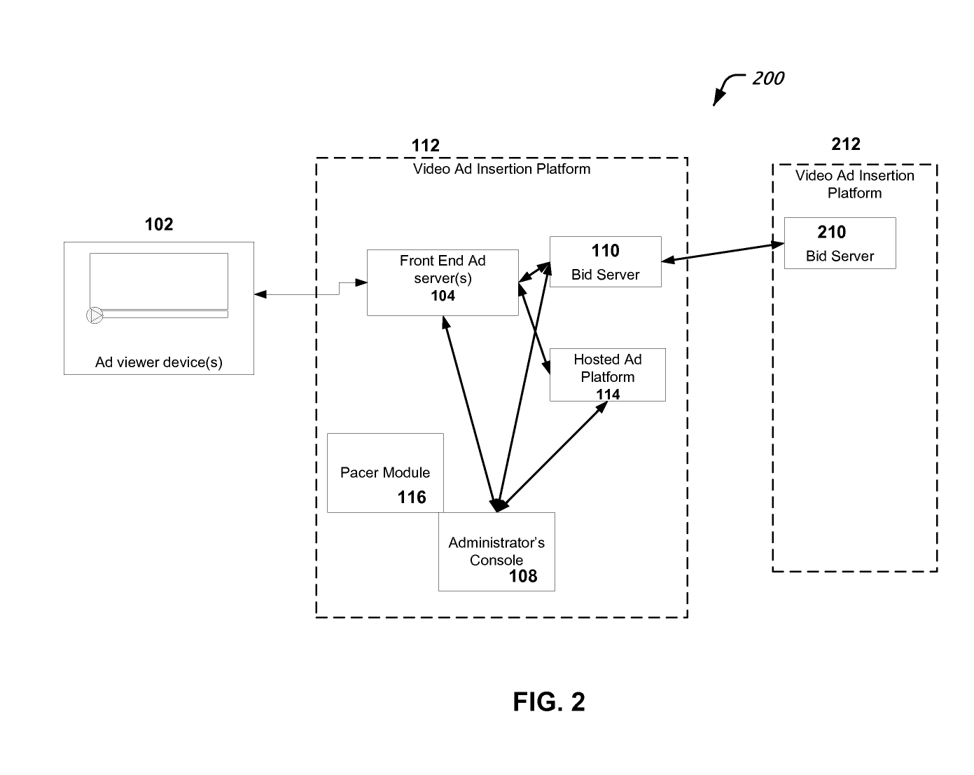

FIG. 2 is a block diagram representation of an example system architecture 200 in which multiple video ad insertion platforms 112, 212 operate as follows. When an ad request is received from a viewer device 102, the bid server 110 may send a bid request to the bid server 210. The bid server 210 may in turn send out bids to its third party advertisers (not shown in FIG. 2). Subsequently, the bid server 210 may submit its winning bid to the bid server 110. At the bid server 110, this winning bid of the bid server 210 is compared with bids from other bidders and a final decision about who gets to display their ad to the user is made. Thus, an ad campaign operating in the video insertion platform 212 may win its bidding, but may not be able to serve out ad to the viewer device. As previously discussed, in system 200, using the number of bids won by an ad campaign as the metric for computing how many ads were served may thus result in incorrect counting of ad serve-outs.

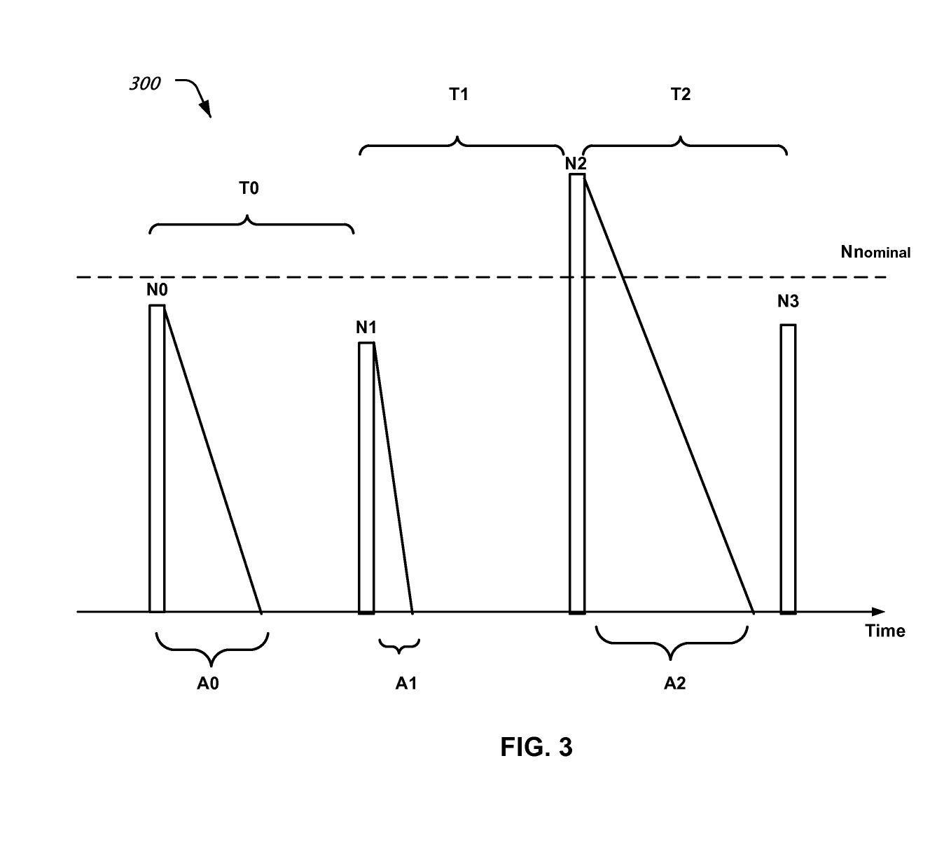

In one illustrative example, an ad campaign may specify that the advertiser desires to show 3 million advertisements to users in a one month period. The pacer module 116 may use this total target number to derive that 100,000 ads are to be placed in each 1 day interval. The pacer module 116 may further sub-divide this into 100,000/(24*4)=(approximately) 1,050 ad serve-out per 15-minute interval rate. Referring to FIG. 3, the time periods T0, T1 and T2 may therefore represent nominal 15 minute intervals, with the dashed line Nₙₒₘᵢₙₐₗ representing the nominal 15 minute interval rate of 1,050 ads to be served out in a given 15-minute interval. For each interval, the pacer module 116 may determine an actual target rate based on an ongoing record-keeping of how many ads were served out previously and what was the success rate of the ads that were served out. For example, the actual target rate N0 in interval T0 may be 1,000. This rate may be less than the nominal rate 1,050 because the pacer module 116 may have determined that a greater percent of ads served out by the system are being actually displayed to users. During the time interval T0, from time to time, or when a next advertisement request is received, the pacer module 116 may check on how many ads of the 1,000 ad actual target rate were previously served out (it may be too soon to have received actual playback information for these ads). For example, during a time interval A0 within the 15-minute interval, every time the pacer module 116 checks for how many ads still remain to be served out, the number may steadily decrease based on ad placements in the interval T0, from 1,000 to zero. After this active ad placement interval A0, the pacer module 116 may control the bidding on the next opportunities, receiving within the interval T0, but outside the active sub-interval A0, so that no bidding is performed on behalf of the ad campaign. Other intervals T1, T2 . . . may also have corresponding active sub-intervals A1, A2 etc.

As further depicted in FIG. 3, at the beginning of each interval, the actual target rates for that interval (NO, N1, N2, N3 etc.) are adjusted upwards or downwards from the nominal rate Nnominal. For example, the actual rate may be adjusted upwards if collected reports indicate that fewer of the previously served out ads were actually played out to users, or if the ad campaign was not able to meet its actual target placements in a previous time period because it was out-bid by other ad campaigns or because of some system errors. Similarly, the actual rate may be adjusted downwards if the collected reports indicate that a greater percent of previously served out ads were played back to users. Similar, the relative amount of time occupied by the active sub-interval A0, A1, A2 . . . within each corresponding interval T0, T1, T2 . . . may change based on the success rate of the ad campaign winning biddings. For example, as depicted, the interval A1 is a much smaller fraction of the period T1, possibly because during that interval, the ad campaign almost always won bids for advertisement requests. Similarly, the sub-interval A2 occupies almost the entire period T2 because during the period T2, other competing ad campaign may have often out-bid the ad campaign depicted in FIG. 3.

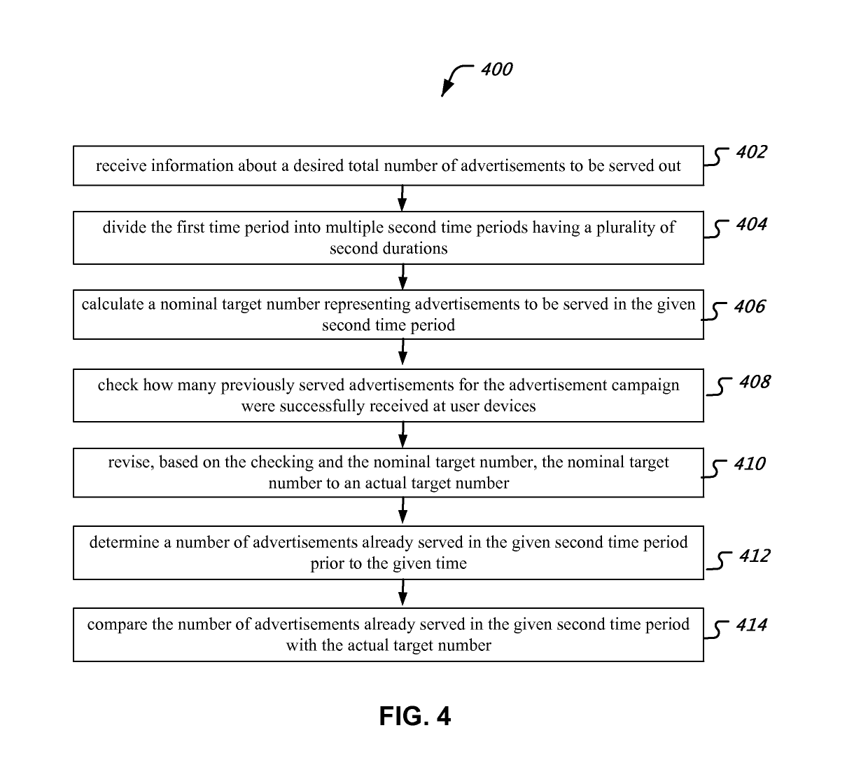

FIG. 4 is a flowchart representation of an example process 400 of controlling online delivery of video advertisements. In various embodiments, the process 300 may be implemented by the pacer module 116, or another server within the video ad insertion platform 112.

At 402, the process 400 receives information about a desired total number of advertisements to be served out for an advertisement campaign over a first time period having a first duration. As previously disclosed, in some embodiments, the first duration may be a 24-hour duration when an ad campaign has an associated per-day ad serve-out target number.

At 404, the process 400 divides the first time period into multiple second time periods having a plurality of second durations. In some embodiments, the first duration (e.g., a 24 hour period) may further be divided into the second time periods that have 15 minute nominal durations. In some embodiments, the total target number of one day may be divided into approximately equal portions into the second durations. For example, the target number N_{D} for one day may be divided into 96 equal (or nearly equal) portions N_{Q} for each quarter-hour duration.

The process 400 may perform the following additional operations for each given second time period.

At 406, the process 400 may calculate a nominal target number representing advertisements to be served in the given second time period. The nominal target number calculation may be performed at the onset of the given second time period or may be performed ahead of time (e.g., target numbers for multiple second time periods may be calculated at once).

At 408, the process 400 may check how many previously served advertisements for the advertisement campaign were successfully received at user devices. In some embodiments, this check may including checking for how many previously served advertisements were served in a second time period immediately prior to the given second time period. In some embodiments, the check may be based on a second time period that is several second time periods away (prior) to the given time period. For example, as previously disclosed, the prior period may be 2 hours prior to the given second time period, representing a delay through the billing system during which feedback is received from various servers in the system.

At 410, the process 400 may revise, based on the checking and the nominal target number, the nominal target number to an actual target number. Using the previous example of serving out 100,000 ads in one day, which translates into approximately 1050 ads per 15-minute interval, in some embodiments, the nominal rate for a 15-minute interval may be set at 1,050 ads. The process may find out that, e.g., 8 hours into the 24 hour period, while 33,600 ads were served out, only 25,000 of these ads were actually received by users, based on playback confirmation. The process 300 may thus adjust the 15-minute nominal rate for the next 15-minute interval to take this deficiency into account so as to catch up with the serve-out deficit. For example, to be able to serve out 75,000 remaining ads in the 16 hour remaining interval, the nominal 15-minute rate may be adjusted upwards to 75,000/(16*4)=1,172 ads. In some embodiments, based on the historical evidence that about 25,000/33,600, or about 75% ads are being successfully played back to users, this rate may further be adjusted to 1,172/0.75=1,563 ads in the next 15-minute intervals. In some embodiments, the actual target number may have to be adjusted downwards from the nominal target number if a greater percent of ads for which bidding was won are being played back to users.

At a given time within the given second time period, the process 400 may perform the following operations.

At 412, the process 400 may determine a number of advertisements already served in the given second time period prior to the given time. In some embodiments, the process 400 may obtain this information by exchanging messages with the front end servers 104 and querying for ads served out in a past near-interval (e.g., within the last 2 or 5 or 10 minutes). For example, at a given time, the process 400 might be 6 minutes into a 15-minute second time period.

At 414, the process 400 may determine the number of advertisements already served in the given second time period with the actual target number.

The process 400, when the actual target number is greater than the number of advertisements already served in the given second time period, may participate for the advertisement campaign in a next advertisement serving opportunity; and

The process 400, when the actual target number is less than or equal to the number of advertisements already served in the given second time period, refrain from participating for the advertisement campaign in the next advertisement serving opportunity.

In some embodiments, the process 400 may further monitor whether or not total advertisements served out during each second time period (e.g., 15 minute interval), or another time period program by the operator (e.g., a one-week trend report) met the target serve-out pace. If the target pace is not met, then the process 400 may alert an operator. This alert may help the operator re-adjust business rules parameters for the ad campaign. For example, if the operator I alerted that an ad campaign is falling behind its target, the operator may be able to re-negotiate the maximum bidding price for the ad campaign to improve its chances of meeting the target rate. In some embodiments, the process 300 may receive updates to the advertisement campaign, which may be based on the operation of alerting. The update may change the total number of advertisements to be served out for the ad campaign or may change the highest bidding price to be used for the ad campaign.

The reach of an online video advertisement network could potentially extend to millions of users, generating hundreds or thousands of advertisement requests to be fulfilled every minute. The process 400, and other techniques described in this document, may therefore be advantageously implemented on a computer or computers that have the processor speed, memory and bandwidth to support the amount of computer message communication and computations involved in the implementation of the operations described in this document. Individual hardware platforms may be dedicated to different tasks, e.g., one computer platform may be configured for performing individual operations (e.g., receiving ad campaign information, deciding whether or not to bid for an advertisement request, etc.). Alternatively, all operations, e.g., discussed with respect to the process 400, may be performed on a single computer platform using a single processor.

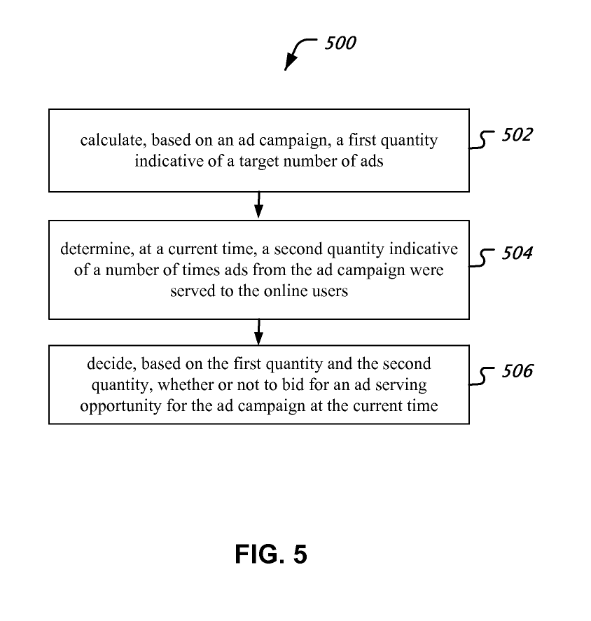

FIG. 5 is a flowchart depiction of an example process 500 of controlling a pace of delivery of online video advertisements to users. The process 500 may be implemented by the pacer module or another server in the video advertisement insertion platform.

At 502, the process 500 calculates, based on an ad campaign, a first quantity indicative of a target number of ads for delivery during a current pacing interval.

At 504, the process 500 determines, at a current time, a second quantity indicative of a number of times ads from the ad campaign were served to the online users during the current pacing interval and up to the current time. In some embodiments, the determination may include exchanging, with each server in a plurality of advertisement servers, messages to collect a corresponding number of video advertisements served by the advertisement servers in a pre-defined prior time period and summing up the numbers collected from each of the plurality of advertisement servers to determine the second quantity. In some embodiments, the pre-defined prior time period may correspond to the time elapsed between a previous message exchange (e.g., the immediately prior message exchange) and the current message exchange.

At 506, the process 500 decides, based on the first quantity and the second quantity, whether or not to bid for an ad serving opportunity for the ad campaign at the current time. In some embodiments, when the second quantity exceeds the first quantity (i.e., when the number of ads served is greater than the target number of ads to be served), the process 500 may refrain from further bidding for ad serving opportunities for the ad campaign during the time interval.

In some embodiments, an online video advertisement delivery system includes a front end server, a billing and reporting mechanism and a pacer module.

The front end server is communicatively coupled to a plurality of user devices and is configured to deliver video advertisements to the plurality of user devices and periodically generate reports of how many video advertisements were delivered in a report period.

The billing and reporting mechanism is configured to receive digital video advertisement playback information from the plurality of user devices and remove redundancies and errors from the received digital video advertisement playback information to generate a billable count of advertisements served for a given advertisement campaign. In some embodiments, the billing and reporting mechanism is further configured to generate the billable count by removing duplicate entries in the received digital video advertisement playback information.

The pacer module 116 may be configured to receive the billable count of advertisements and an instantaneous number of video advertisements served in a predefined prior first time window, and control, based on the billable count of advertisements and the instantaneous number of video advertisements served in the predefined prior time window, a number of video advertisements to be placed in an upcoming second time window. In some embodiments, the pacer module is further configured to determine a long term target pace for placing digital video advertisements based on the billable count of advertisements and determine a short term target pace for placing digital video advertisements based on the instantaneous number of video advertisements served in the predefined prior time window. In some implementations, the long term target pace is determined for a first time period substantially equal to a period at which the front end server periodically generates reports.

In some embodiments, the system may further include a bidding server. The bidding server may be configured to conduct an auction for an opportunity to place a video advertisement.

In some embodiments, the system may further include a hosted digital video advertisement server configure to bid, under control of the pacer module, for the auction on behalf of the advertisement campaign.

In some embodiments, an advertisement campaign may provide additional pacing criteria that may be based on user profile or geographic distribution of users or some other characteristics of user devices. For example, an ad campaign may specify that it desires to place 100,000 ads in a month on the West Coast, while desiring to place 200,000 ads a month on the East Coast. As another illustrative example, an advertisement campaign may want to target user devices with Apple is platforms exclusively or more often (e.g., twice as many) than user devices with Windows or another operating system.

The pacer module may take into account these additional rules from advertisement campaigns by analyzing the ad campaign-provided rules into individually trackable serve-out rates. For example, in the above examples, the pacer module may control serve-out rate of advertisements to West Coast (or to iOS user devices) separately from the serve-out rate to the East Coast or to Windows-based user devices.

It will be appreciated that the present document discloses techniques for controlling a pace of delivery of video advertisements to online users. In one aspect, the target reach-out goal of an advertisement campaign is translated into a first level of granularity (e.g., a monthly ad target to a daily ad target, or a country-wide ad target to regional ad targets). In some embodiments, the target serve-out rates at the first granularity may further be divided into a second level of granularity based on, e.g., smaller time intervals. Within each time interval, for every advertisement request received, an actual target rate may be compared against the number of ads served out, as reported by an ad server, to decide whether or not to bid for the advertisement request.

It will further be appreciated that, in one aspect, the disclosed techniques allow for the control of the pace at which video advertisements are placed, using information about short-term (e.g., last two minutes or last 15 minutes) serve-out rates along with a longer term serve-out rate that is adjusted based on feedback from user devices about actual consumption of the ad on the user device.

The disclosed and other embodiments and the functional operations and modules described in this document (e.g., the pacer module 116) can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for controlling online delivery of video advertisements in a network of communication devices or computers, comprising:
receiving information about a desired total number of advertisements to be served out for an advertisement campaign in the network over a first time period having a first duration;
dividing the first time period into multiple second time periods having a plurality of second durations;
for each given second time period:
calculating a nominal target number representing advertisements to be served in the given second time period;
checking how many previously served advertisements for the advertisement campaign were successfully received at user devices;
revising, based on the checking and the nominal target number, the nominal target number to an actual target number;
at a given time within the given second time period:
determining a number of advertisements already served in the given second time period prior to the given time;
comparing the number of advertisements already served in the given second time period with the actual target number; and
if the actual target number is greater than the number of advertisements already served in the given second time period, then participating for the advertisement campaign in a next advertisement serving opportunity; and
if the actual target number is less than or equal to the number of advertisements already served in the given second time period, then refraining from participating for the advertisement campaign in the next advertisement serving opportunity.

2. The method of claim 1, wherein the checking operation comprises:
receiving information from one or more advertisement servers indicative of advertisements served out to user devices; and
receiving information indicative of advertisements received at user devices, as reported by the user devices.

3. The method of claim 1, wherein the second durations are substantially identical in value to each other and wherein the nominal target numbers of the second time periods are substantially identical in value to each other.

4. The method of claim 1, wherein the participating for the advertisement campaign includes bidding for the next advertisement serving opportunity.

5. The method of claim 1, wherein the checking for previously served advertisements includes checking for how many previously served advertisements were served in a second time period immediately prior to the given second time period.

6. The method of claim 1, wherein the advertisement campaign specifies the first time period but not the second time period.

7. The method of claim 1, further comprising:
monitoring, for each second time period, whether or not the total advertisements served in that time period matched the actual target number; and
alerting an operator when the total advertisements served in that time period does not match the actual target number.

8. The method of claim 7, further comprising:
receiving an update to the advertisement campaign based on the operation of alerting the operator, wherein the update changes at least one of the desired total number of advertisements or a highest bidding price to be used for the next advertisement serving opportunity.

9. The method of claim 1, wherein the operation of determining the number of advertisements already served in the given second time period prior to the given time includes receiving real-time advertisement serving information from an advertisement server without receiving a corresponding ad reception confirmation from user devices to whom the advertisements were served.

10. A computer program product comprising a computer-readable medium having code stored thereupon, the code, when executed, causing a processor to implement a method of controlling delivery of video advertisements to online users, comprising:
calculating, based on an ad campaign, a first quantity indicative of a target number of ads for delivery during a current pacing interval;
determining, at a current time, a second quantity indicative of a number of times ads from the ad campaign were served to the online users during the current pacing interval and up to the current time; and
deciding, based on the first quantity and the second quantity, whether or not to bid for an ad serving opportunity for the ad campaign at the current time.

11. The computer program product of claim 10, wherein the calculating the first quantity includes:
dividing a total number of video advertisement deliveries authorized by the ad campaign by a number of pacing intervals over which the ad campaign extends.

12. The computer program product of claim 10, wherein the determining the second quantity includes:
exchanging, with each server in a plurality of advertisement servers, messages to collect a corresponding number of video advertisements served by the advertisement servers in a pre-defined prior time period; and
summing up the numbers collected from each of the plurality of advertisement servers to determine the second quantity.

13. The computer program product of claim 12, wherein the pre-defined time period includes a time elapsed between previous message exchange and the current message exchange.

14. The computer program product of claim 12, wherein the deciding whether or not to bid includes:
deciding to refrain from bidding when the second quantity exceeds the first quantity.

15. An online video advertisement delivery system, comprising:
a front end server communicatively coupled to a plurality of user devices and configured to:
deliver video advertisements to the plurality of user devices; and
periodically generate reports of how many video advertisements were delivered in a report period;
a billing and reporting mechanism configured to:
receive digital video advertisement playback information from the plurality of user devices; and
remove redundancies and errors from the received digital video advertisement playback information to generate a billable count of advertisements served for a given advertisement campaign; and
a pacer module configured to:
receive the billable count of advertisements and an instantaneous number of video advertisements served in a predefined prior first time window; and
control, based on the billable count of advertisements and the instantaneous number of video advertisements served in the predefined prior time window, a number of video advertisements to be placed in an upcoming second time window.

16. The system of claim 15, wherein the billing and reporting mechanism is further configured to generate the billable count by removing duplicate entries in the received digital video advertisement playback information.

17. The system of claim 15, wherein the pacer module is further configured to:
determine a long term target pace for placing digital video advertisements based on the billable count of advertisements; and
determine a short term target pace for placing digital video advertisements based on the instantaneous number of video advertisements served in the predefined prior time window.

18. The system of claim 15, wherein the long term target pace is determined for a first time period substantially equal to a period at which the front end server periodically generates reports.

19. The system of claim 15, further comprising:
a bidding server configured to:
conduct an auction for an opportunity to place a video advertisement; and
a hosted digital video advertisement server configured to:
bid, under control of the pacer module, for the auction on behalf of the advertisement campaign.

20. The system of claim 19, wherein the pacer module is further configured to control the hosted digital video advertisement served to refrain from bidding on behalf of the advertisement campaign when the number of video advertisements to be placed in an upcoming second time window is zero.
